(19) United States
(12) Patent Application Publication
(10) Pub. No.: US 2026/0023979 A1
(43) Pub. Date: Jan. 22, 2026

(54) ARTIFICIAL INTELLIGENCE DEVICE FOR PERSONAL LARGE LANGUAGE MODEL AGENTS FOR COMPLEX TASK EXECUTION AND METHOD THEREOF

(71) Applicant: LG ELECTRONICS INC., Seoul (KR)

(72) Inventors: Homa FASHANDI, Toronto (CA); Harmanpreet SINGH, Toronto (CA); Yixiao WANG, Toronto (CA); Nikhil VERMA, Toronto (CA); Manasa BHARADWAJ, Scarborough (CA)

(73) Assignee: LG ELECTRONICS INC., Seoul (KR)

(21) Appl. No.: 19/272,881

(22) Filed: Jul. 17, 2025

Related U.S. Application Data
(60) Provisional application No. 63/672,696, filed on Jul. 17, 2024.

(51) Int. Cl. G06N 3/091

(52) U.S. Cl. CPC G06N 3/091

(57) ABSTRACT

A method for controlling an artificial intelligence (AI) deice can include obtaining a user query and user-related information, the user related information includes one or more of user preferences, user history and user personal concepts, generating, by a structured user model synthesizer, a structured user model based on the user-related inputs, generating, by a personalized task execution engine, a personalized result for the user query by integrating the structured user model and external data, and outputting the personalized result. Also, at least one of the structured user model synthesizer and the personalized task execution engine is a large language model based agent.

### CROSS-REFERENCE TO RELATED APPLICATIONS

This non-provisional application claims priority under 35 U.S.C. § 119(e) to U.S. Provisional Application No. 63/672,696, filed on Jul. 17, 2024, the entirety of which is hereby expressly incorporated by reference into the present application.

### BACKGROUND

### Field

The present disclosure relates to a device and method for personalizing large language model (LLM) agents for executing complex tasks, in the field of artificial intelligence (AI). Particularly, the method can implement a framework that generates and leverages a structured user model to provide enhanced task personalization and a quantitative assessment of the output's alignment with user preferences.

### Discussion of the Related Art

Artificial intelligence (AI) has seen significant advancements, particularly with the development of Large Language Models (LLMs). These models have evolved from simple text generators into sophisticated agents capable of performing complex, multi-step tasks. These LLM agents are increasingly being deployed to assist users in a wide range of real-world applications.

While the functional capabilities of these LLM agents have grown, their approach to task execution remains impersonal and generic. For example, existing systems typically process a user's query without a deep understanding of the user's individual preferences, attributes or history. Accordingly, the outputs are often one-size-fits-all solutions that fail to align with the unique needs and desires of the individual user, which can lead to a suboptimal user experience and reduced overall effectiveness.

This lack of personalization is a significant limitation. For example, when tasked with planning an activity, a generic agent may suggest popular options but will be incapable of recommending a specific restaurant that accommodates a user's dietary restrictions, a hotel that allows the user's pet, or an activity that aligns with the user's hobbies. This forces the user to perform significant additional manual filtering and research, thereby defeating the purpose of using an automated agent for the task.

Further challenges exists due to the absence of a robust framework for evaluating the quality of personalization. Conventional metrics for LLM agents typically focus on task success. However, these metrics fail to capture the subjective aspects of how well an output is tailored to a user's preferences. Existing methods lack a systematic way to quantify whether a generated plan is merely adequate or truly personalized and useful for a specific user.

Thus, a need exists for an improved method and device that can enable large language model agents to execute complex tasks in a personalized manner that is tailored to an individual user's specific context, preferences and history.

Furthermore, a need exists for a framework that can quantitatively evaluate the quality of personalization in an agent's output. Such a method is needed to move beyond generic task-completion metrics and provide a robust, automated assessment of how well a result aligns with a user's unique profile, thereby ensuring a more effective and satisfying user experience.

Also, a need exists for a comprehensive framework that can systematically generate personalized outputs by leveraging a structured user model and can validate the effectiveness of the personalization through a comparative analysis performed by an automated, AI-driven judge.

### SUMMARY OF THE DISCLOSURE

The present disclosure has been made in view of the above problems and it is an object of the present disclosure to provide a device and method that can provide improved personalization for large language model (LLM) agents executing complex, real-world tasks. Further, the method can provide enhanced personalization by implementing a framework that generates and leverages a structured user model to tailor task execution to an individual's preferences and quantitatively assesses the quality of the personalized output.

An object of the present disclosure is to provide an artificial intelligence (AI) device and method for a personal large language model (LLM) agent framework that executes complex tasks tailored to an individual user. The method can utilize a multi-component framework to systematically generate and evaluate personalized outputs. For example, a user model synthesizer component can first generate a structured user model that encapsulates a user's preferences, history and personal concepts. Then, a personalized task execution engine can process a user query by integrating the structured user model with external data to produce a personalized result, while optionally a baseline execution engine generates a generic result. Further, an automated quality assessor, configured as an LLM-as-a-Judge, can compare the personalized and generic results against the structured user model to identify the preferred output and provide a reasoned justification for its selection. This can produce a highly personalized and contextually relevant output for the user while also providing a quantitative measure of the personalization's effectiveness, thereby enhancing user satisfaction and overall system utility.

Another object of the present disclosure is to provide a method for controlling an artificial intelligence (AI) device that can include obtaining a user query and user-related information, the user related information includes one or more of user preferences, user history and user personal concepts, generating, by a structured user model synthesizer, a structured user model based on the user-related inputs, generating, by a personalized task execution engine, a personalized result for the user query by integrating the structured user model and external data, and outputting the personalized result. Also, at least one of the structured user model synthesizer and the personalized task execution engine is a large language model based agent.

It is another object of the present disclosure to provide a method that further includes generating, by a baseline task execution engine, a non-personalized result for the user query based on the external data and without using the structured user model, evaluating, by an automated personalization quality assessor, the personalized result and the non-personalized result based on the structured user model and the user query, and generating, by the automated personalization quality assessor, a verdict identifying a preferred result between the personalized result and the generic result.

Yet another object of the present disclosure is to provide a method that further includes selecting one of the personalized result and the non-personalized result based on the verdict to determine a selected result, and outputting the selected result.

An object of the present disclosure is to provide a method, in which the automated personalization quality assessor is a large language model (LLM) configured as an LLM-as-a-Judge.

Another object of the present disclosure is to provide a method that further include assessing the personalized result and the non-personalized result based on one or more performance indicators including one or more of a delivery metric, a common-sense pass metric, a hard constraint pass metric, and a final pass metric.

An object of the present disclosure is to provide a method, in which the verdict further includes a detailed justification explaining identification of the preferred result.

Yet another object of the present disclosure is to provide a method, in which the structured user model synthesizer is a large language model (LLM) based agent configured to populate a predefined schema based on the user-related information.

An object of the present disclosure is to provide a method, in which the structured user model synthesizer includes a retrieval augmented generation (RAG) architecture.

Another object of the present disclosure is to provide a method, in which the integrating the structured user model includes a non-parametric approach of incorporating data from the structured user model into a prompt for the personalized task execution engine.

An object of the present disclosure is to provide a method, in which the integrating the structured user model includes a parametric approach of adapting the personalized task execution engine to the structured user model using at least one of fine-tuning, adapter layers, Low-Rank Adaptation (LoRA), and soft prompt tuning.

An object of the present disclosure is to provide a method, in which the personalized task execution engine is a large language model (LLM) agent that employs a planning strategy selected from a group including Direct, Chain-of-Thought (CoT), ReAct, and Reflexion.

Another object of the present disclosure is to provide an artificial intelligence (AI) device including a memory configured to store information for a large language model, and a controller configured to obtain a user query and user-related information, the user related information includes one or more of user preferences, user history and user personal concepts, generate, by a structured user model synthesizer, a structured user model based on the user-related inputs, generate, by a personalized task execution engine, a personalized result for the user query by integrating the structured user model and external data, and output the personalized result, in which at least one of the structured user model synthesizer and the personalized task execution engine is a large language model based agent.

An object of the present disclosure is to provide a non-transitory computer readable medium storing computer-executable instructions that when executed by a processor, cause the processor to perform the operations of obtaining a user query and user-related information, the user related information includes one or more of user preferences, user history and user personal concepts, generating, by a structured user model synthesizer, a structured user model based on the user-related inputs, generating, by a personalized task execution engine, a personalized result for the user query by integrating the structured user model and external data, and outputting the personalized result, in which at least one of the structured user model synthesizer and the personalized task execution engine is a large language model based agent.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates an example encoder-decoder based transformer architecture for a large language model according to an embodiment of the present disclosure.

FIG. 5 illustrates an example flow chart for a method of controlling an AI device according to an embodiment of the present disclosure.

FIG. 6 illustrates an overview of a pipeline architecture for a personalized agent framework according to an embodiment of the present disclosure.

FIG. 7 illustrates an overall workflow of a personalized agent framework as applied to an example situation of a travel planner, according to an embodiment of the present disclosure.

FIG. 8, including parts (a) and (b), illustrates task planning workflows, according to an embodiment of the present disclosure.

FIG. 9 illustrates a task planning workflow, according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship. Also, the term “can” used herein includes all meanings and definitions of the term “may.”

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user. For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

In addition, the self-driving vehicle can be regarded as a robot having a self-driving function.

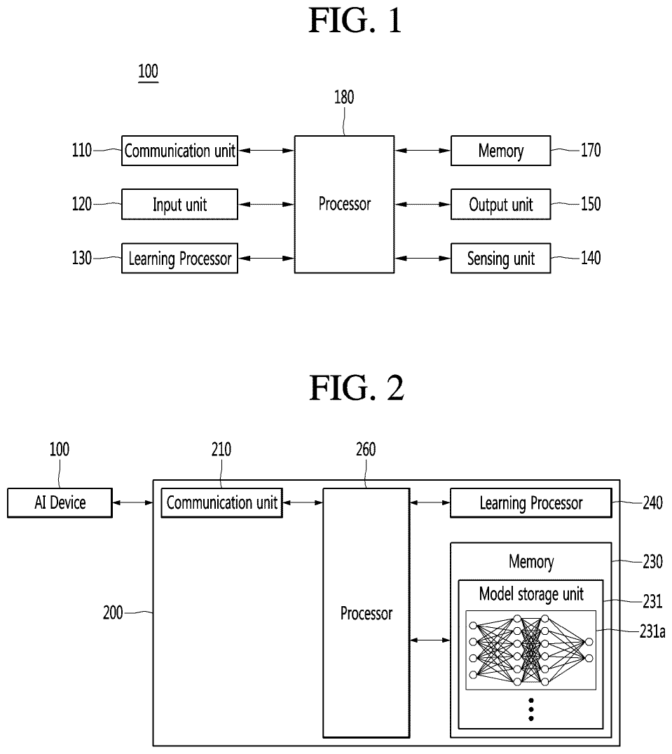

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

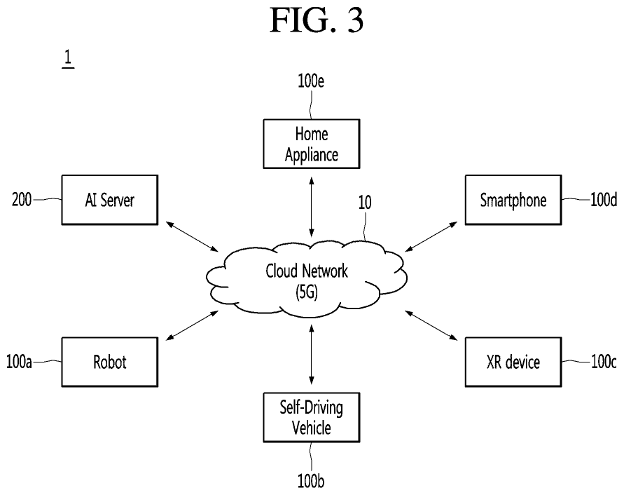

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

In addition, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire learning data for model learning and input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

Also, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

Also, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a machine learning algorithm. The processor 180 can control the components of the AI device 100 to execute the determined operation. For example, the processor 180 can implement an AI model to generate output based on a plurality of modalities. Also, the generated output can be used by AI systems in various downstream related tasks other than text generate (e.g., object identification, control instructions to move a robot, control maneuvering for a self-driving vehicle, in game content generation, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is used to perform the determined operation, the processor 180 can generate a control signal for controlling the external device and can transmit the generated control signal to the external device.

The processor 180 can acquire information from the user input and produce an answer to a query, carry out an action or movement, animate a displayed avatar or a recommend an item or action.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including user profile information, the operation contents of the AI device 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The AI model can be implemented in hardware, software, or a combination of hardware and software. If all or part of the learning models are implemented in software, one or more instructions that constitute the learning model can be stored in the memory 230.

The processor 260 can infer the result value for new input data by using the AI model and can generate a response or a control command based on the inferred result value.

FIG. 3 illustrates an AI system 1 including a terminal device according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

According to an embodiment, the method can be implemented as an interactive application or program that can be downloaded or installed in the smartphone 100d, which can communicate with the AI server 200, but embodiments are not limited thereto.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data. According to embodiments, the AI model can be fully implemented on an edge device (e.g., locally on devices 100a to 100e) or fully implemented AI server 200 in which an edge device collected the raw audio and video signals to provide to the AI server 200. According to another embodiment, parts of the AI model can be distributed across both of an edge device and the AI server 200.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

In addition, the AI server 200 can learn the artificial neural network according to the machine learning algorithm instead of the AI devices 100a to 100e, and can directly store the learning model or transmit the AI model to the AI devices 100a to 100e.

Further, the AI server 200 can receive input data from the AI devices 100a to 100e, can infer the result value for the received input data by using the AI model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

According to an embodiment, the home appliance 100e can be a smart television (TV), smart microwave, smart oven, smart washing machine or dryer, smart refrigerator or other display device, which can implement one or more of a large language model (LLM), a chat-bot, a digital avatar assistant, an online shopping assistant or concierge, a question and answering system or a recommendation system, etc. The method can be in the form of an executable application or program.

The robot 100a, to which the AI technology is applied, can be implemented as an entertainment robot, a guide robot, a carrying robot, a cleaning robot, a wearable robot, a pet robot, an unmanned flying robot, a home robot, a care robot or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the AI model composed of at least one artificial neural network. For example, the robot 100a can recognize the surrounding environment and the objects by using the AI model, and can determine the operation by using the recognized surrounding information or object information. The learning model can be learned directly from the robot 100a or can be learned from an external device such as the AI server 200.

Also, the robot 100a can perform the operation by generating the result by directly using the AI model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan. Further, the robot 100a can determine an action to pursue, generate an output or an item to recommend. Also, the robot 100a can generate an answer in response to a user query and the robot 100a can have animated facial expressions. The answer can be in the form of natural language.

The map data can include object identification information about various objects arranged in the space in which the robot 100a moves. For example, the map data can include object identification information about fixed objects such as walls and doors and movable objects such as desks. The object identification information can include a name, a type, a distance, and a position.

In addition, the robot 100a can perform the operation or travel by controlling the driving unit based on the control/interaction of the user. Also, the robot 100a can acquire the intention information of the interaction due to the user's operation or speech utterance, and can determine the response based on the acquired intention information, and can perform the operation while providing an animated face.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

In addition, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b and the user's emotional state, or can control the function of the self-driving vehicle 100b through the interaction with the user. For example, when it is determined that the driver is in a drowsy state or an angry state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Also, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle. Also, the robot 100a can provide information and services to the user via a digital avatar, which can be personally tailored to the user based on the user's personal preferences.

According to an embodiment, the AI device 100 can provide a method for personalizing the execution of complex tasks by large language model (LLM) agents by generating and leveraging a structured user model and multi-component framework to produce outputs tailored to an individual user's preferences and context.

According to another embodiment, the AI device 100 can be integrated into an infotainment system of the self-driving vehicle 100b, which can recognize different users and their emotional states, and recommend content, provide personalized services or provide answers based on various input modalities, the content can include one or more of audio recordings, video, music, pod casts, etc., but embodiments are not limited thereto. Also, the AI device 100 can be integrated into an infotainment system of the manual or human-driving vehicle.

As discussed above, embodiments of the present disclosure relate to the field of artificial intelligence (AI) and machine learning, and more particularly, to methods and systems for or personalizing the behavior of large language model (LLM) agents to enhance their effectiveness in executing complex, real-world tasks.

For example, embodiments of the present disclosure can provide for a personalized task execution framework for artificial intelligence agents, which can be viewed as a foundational component for applications desiring user-centric outputs, such as travel planners, automated financial advisors, personalized content curators, and adaptive educational tutors.

As discussed above, the operational capabilities of artificial intelligence agents face several challenges that limit their practical utility and user satisfaction. While these agents have become proficient at executing multi-step instructions, their interaction model is often superficial. The performance of these agents in real-world scenarios depends on their ability to understand the query from a user, but also the surrounding context and needs of the user.

One challenge is the lack of a persistent, structured understanding of the individual user. Related methods often operate on a session-by-session basis, without a deep model of a user's preferences, habits and personal history.

For example, a user might ask a conventional agent to draft a project proposal. The agent may successfully generate a document that meets the explicit requirements of the query, but it will be unaware of the user's preferred writing style or the specific formatting used in the user's organization. This forces the user to manually edit and personalize the generic output, which is inefficient and undermines the value of using an automated agent.

Another example of this limitation can be seen in task-planning scenarios. A user might ask an agent to create a vacation plan. A conventional agent might suggest a popular tourist destination. However, it would be incapable of knowing that the user has two small children and a dog named “Goldie,” requires family-friendly accommodations that are also pet friendly, has a strong preference for educational activities over beaches, and has a personal preference that finds visiting museums and historical sites to be a preferred form of relaxation. The resulting generic plan would be technically a valid vacation plan but could still be entirely misaligned with the user's actual needs and desires, making it practically useless without substantial modification by the user.

A further challenge in the existing art is the absence of a meaningful framework for evaluating the quality of personalization. They do not distinguish between a plan that is merely adequate and one that is truly personalized and delightful for the user. Accordingly, a need exists for an improved system and method that can create a persistent and structured model of a user to drive personalized task execution and a corresponding evaluation framework to quantitatively measure the effectiveness of that personalization.

According to an embodiment, the AI device 100 can provide a personalized task execution framework that overcomes the limitations of prior approaches. For example, a multi-component framework can be employed that utilizes one or more artificial intelligence models, in which different components are configured to perform specialized tasks.

The framework can include a user model synthesizer to generate a structured profile of a user's preferences and context, a personalized task execution engine to generate a tailored result based on that profile, and an automated quality assessor to quantitatively evaluate the personalization by comparing the tailored result to a generic baseline, thereby ensuring a demonstrably superior and user-aligned output.

An LLM-based framework can offer many advantages. For example, Large Language Models (LLMs) can be used to implement the various components of the framework, such as the synthesizer, the execution engine, and the quality assessor. These models can be configured to understand complex natural language queries and generate coherent, human-like responses, which enables the framework to interpret nuanced user data and provide detailed, reasoned justifications for its evaluations.

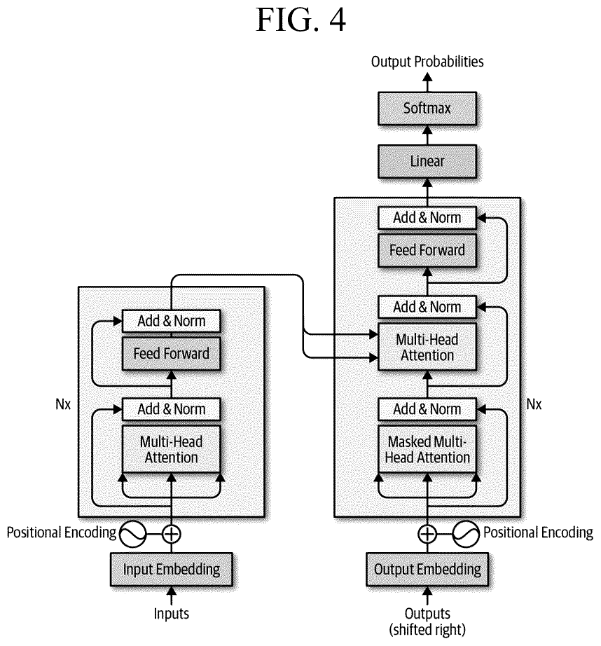

FIG. 4 illustrates an example encoder-decoder based transformer architecture for a large language model according to an embodiment of the present disclosure. For example, the method can leverage one or more large language models (LLMs). According to an embodiment, the LLM can be based on an encoder-decoder architecture, which employs self-attention mechanisms.

Further, these attention mechanisms can allow the model to weigh the importance of different parts of an input sequence (e.g., words in a sentence or sentences in a document) when processing information to allow the model to capture long-range dependencies and contextual relationships effectively, which is particularly relevant for understanding complex user queries or detailed product descriptions.

According to an embodiment, the LLM can undergo its own pre-training phase, in which the LLM is trained on a massive and diverse amount of text and code. During this unsupervised or self-supervised learning stage, the model can learn fundamental language patterns, grammatical structures, factual knowledge, and even reasoning capabilities (e.g., predicting masked words or the next sequence of text).

According to an embodiment, the LLM portion can be subject to a fine-tuning phase. Fine-tuning can involve further training the pre-trained model on smaller, more specialized datasets tailored to specific tasks (e.g., question answering, summarization, specific domain knowledge) or to align the model's behavior with desired characteristics, such as improved instruction following or safety protocols. According to embodiments, the AI model can advantageously utilize pre-trained LLMs, potentially without requiring extensive task-specific fine-tuning for its core agent functionalities. For example, according to an embodiment, the AI model can be LLM agnostic, but embodiments are not limited thereto.

For example, the LLM portion can operate by processing textual inputs (e.g., prompts) which can include questions, instructions, or other text intended to elicit a specific response. The LLM can leverage its learned knowledge to generate a corresponding textual output, such as an answer, a summary, or other contextually relevant content. Also, according to an embodiment, the LLM portion can be multi-modal to accept and operate on other types of input, such as images, video, etc.

In addition, one or more of the various components of the framework can be configured as artificial intelligence agents (e.g., AI agents). For example, an AI agent can be an autonomous computational system designed to process information and take actions to achieve specific goals. An agent can receive inputs, perform reasoning about those inputs based on its internal logic and knowledge, and produce outputs or executes tasks in response. According to embodiments, these agents can range from rule-based systems to highly complex models capable of sophisticated reasoning and decision-making.

According to an embodiment, the one or more AI agents can be based on Large Language Models (LLMs) that can be endowed with more sophisticated capabilities, such as planning, memory and the ability to use external tools.

For example, a planning module can allow the agent to decompose a high-level goal into a sequence of smaller, manageable steps. A memory module can provide the agent with the ability to retain information from past interactions, allowing it to maintain context and learn over time.

Further, the ability to use external tools can enable the agent to interact with other software, APIs or data sources to gather information or perform actions to execute a wide variety of complex, real-world tasks.

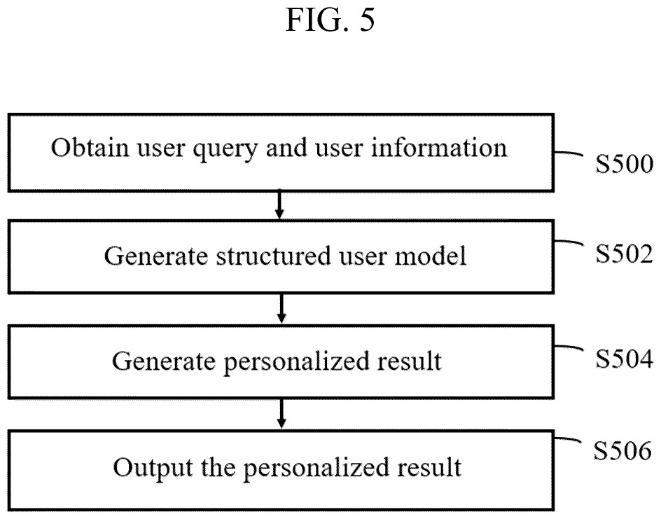

FIG. 5 shows an example flow chart of a method according to an embodiment of the present disclosure. For example, according to an embodiment, a method for controlling an AI device can include obtaining a user query and user-related information, the user related information includes one or more of user preferences, user history and user personal concepts (e.g., S500), generating, by a structured user model synthesizer, a structured user model based on the user-related inputs (e.g., S502), generating, by a personalized task execution engine, a personalized result for the user query by integrating the structured user model and external data (e.g., S504), and outputting the personalized result (e.g., S506). Also, at least one of the structured user model synthesizer and the personalized task execution engine can be a large language model based agent.

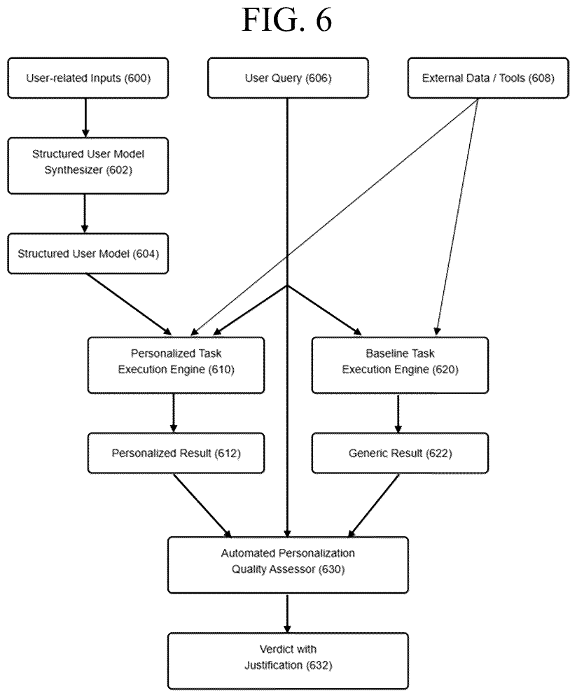

FIG. 6 is a flowchart illustrating an example of the personal agent framework, according to an embodiment of the present disclosure. For example, according to an embodiment, the AI model can be implemented as a cohesive architecture of interconnected modules designed to implement the multi-phase workflow previously described.

The process can include obtaining a set of initial inputs for task execution. These inputs can include user-related inputs (600), which can include any data associated with a user, such as their stated preferences, historical data, personal concepts, or demographic information. For example, the user-related inputs can be input by the user and/or retrieved from memory or external sources and tools (e.g., purchase history, viewing history, book reading list, location and map data, etc.).

In addition, the inputs can also include a specific user query (606) or command, which can define a high-level task that the user wants the agent to perform. Also, one or more modules for external data/tools (608) can be for obtaining any relevant reference information, databases, or APIs that the system can access to complete the task.

For example, the external data and tools module(s) can provide map access, store information, shopping information, restaurant information, booking information, education information, financial information, travel information, etc., but embodiments are not limited thereto.

Further in this example, the user-related inputs (600) can be processed by a structured user model synthesizer (602). The structured user model synthesizer (602) can create a detailed and structured representation of the user or user model. In some embodiments, the synthesizer 602 can be implemented as a large language model (LLM) that processes the various user inputs to populate a predefined schema, e.g., according to a predefined prompt. According to embodiments, the structured user model synthesizer can be referred to as a structured user model generator or user model agent.

In other embodiments, the synthesizer 602 can utilize a Retrieval Augmented Generation (RAG) architecture to extract relevant information about the user from the provided data. The output of the structured user model synthesizer (602) can be a structured user model (604), which can be a formal, machine-readable profile encapsulating the user's preferences and personal context. The structured user model 604 can serve as a persistent knowledge base that can be utilized by other components in the framework. Also, the structured user model can be stored in the memory of the AI device 100.

In addition, the framework can include one or more task execution engines that process the user query (606), e.g., the personalized task execution engine (610) and the baseline task execution engine (620).

According to an embodiment, the personalized task execution engine (610) and the baseline task execution engine (620) can be configured as AI agents. Also, the baseline task execution engine (620) can be omitted according to design considerations and embodiments.

Further in this example, the personalized task execution engine (610) can integrate the structured user model (604), the user query (606), and the external data/tools (608). The integration of the user model 604 can be achieved through various means (e.g., such as populating portions of a predefined prompt, etc.).

In some non-parametric embodiments, the user model data can be incorporated directly into the prompt fed to the execution engine 610. In other parametric embodiments, the engine 610 can be adapted to the user model through techniques such as fine-tuning, adapter layers, Low-Rank Adaptation (LoRA), or soft prompt tuning.

By leveraging the user model 604, the personalized engine 610 can interpret the query in the user's specific context to produce a personalized result (612) that is tailored to satisfy the hard constraints of the query and the user's implicit preferences.

In addition, a baseline task execution engine (620) can process the user query (606) using the external data/tools (608), without access to the structured user model (604). For example, the baseline task execution engine can produce a generic result (622) that satisfies the explicit requirements of the query but lacks any personalization. For example, here the term “generic” is used to refer to a non-personalized result, and not to be confused with the term obvious.

According to an embodiment, the generic result (622) can serve as a control or baseline for evaluating the effectiveness of the personalization process, or as a backup option or alternative option to provide to the user, e.g., if the personalized result fails one or more evaluation metrics.

Further in this example, the personalized result (612) and the generic result (622) can then be passed to an automated personalization quality assessor (630). This assessor component, which can be configured as an LLM-as-a-Judge, can perform a comparative analysis of the two results. According to embodiment, the automated personalization quality assessor can be referred to as an evaluation agent, an evaluator, etc.

Also, the assessor 630 can be provided with the original user query (606) and the structured user model (604). For example, the assessor 630 can evaluate how well each result aligns with the user's complete profile, including their nuanced preferences and personal concepts, as well as constraints form the user query and external data and tools.

Further, the output of the framework can be a verdict with justification (632), in which the assessor (630) identifies the preferred result (e.g., often the personalized result) and provides a detailed explanation for its choice, thereby offering a quantitative and qualitative measure of the personalization's impact.

According to an embodiment, the verdict or evaluation output by the assessor (630) can be used to make a selection between the personalized result (612) and the generic result (622), and the selected result can be returned to the user as a response to the original query, and the selected result can be output to the user. For example, the selected result can be displayed on a display of the AI device 100 and/or output via audio through one or more speakers of the AI device 100.

In other words, in some contexts, it may make more sense to provide the user with a generic result instead of a personalized result (e.g., such as in a situation where personalization would be inappropriate or where the personalized results failed one or more evaluation metrics). Thus, the method can provide flexibility to dynamically determine between providing the personalized result (612) and the generic result (622), which can increase user convenience and improve satisfaction.

According to another embodiment, both of the personalized result (612) and the generic result (622) can be provided to the user. Also, the user can select one of the two results, which can form a basis of providing feedback to further fine tune or train the model and provide better personalization.

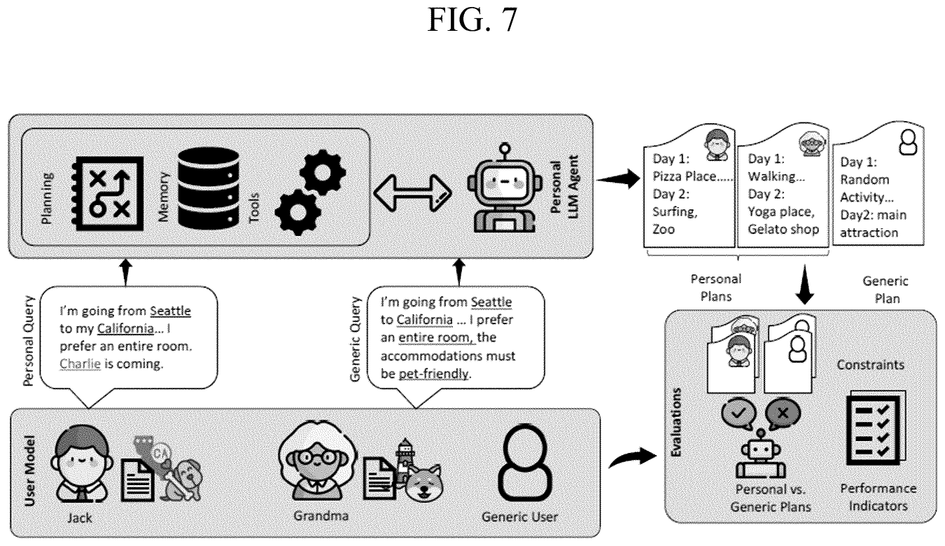

FIG. 7 illustrates an overall workflow of the personalized agent as applied to an example situation of a travel planner, according to an embodiment. A travel planner is one example of a possible use case scenario to which the method can be applied, but embodiments are not limited thereto and the method can be applied to other tasks, according to embodiments.

For example, according to an embodiment, the personal agent framework, implemented as a travel planning agent as shown in FIG. 7, can be referred to as “TravelPlanner+.” This embodiment demonstrates how the framework can generate highly personalized travel itineraries.

For example, the process can include gathering a set of inputs (e.g., user-related inputs), which for a travel application can include the user's interests (e.g., museums, hiking), favorite cuisines, activity preferences, and personal concepts (e.g., a pet's name, such as “Goldie”).

The inputs can also include a specific user query, such as a request to plan a three-day trip for a specific number of people to a particular city, and external data/tools can provide lists of hotels, restaurants, flights, and attractions relevant to the destination city. According to an embodiment, the external data/tools can be in the form of one or more plug-ins or one or more other AI agents.

Further in this example, the user-related inputs can be processed by the structured user model synthesizer. In this travel planning embodiment, the synthesizer can be configured to create a structured representation of a user's travel profile or user model.

For example, the model synthesizer can be used to help capture travel specific information for that user which can be used for handling customized language in user queries, such as recognizing that a request for a “pet-friendly” hotel should accommodate the user's dog, “Goldie.” The output of the model generator can be a comprehensive structured user model that can serve for subsequent personalization.

Table I below shows two examples of user models, according to an embodiment of the present disclosure.

TABLE I

| | |
|---|---|
| Demographics: | Demographics: |
| Age Range: 45-54 | Age Range: 18-24 |
| Gender: Male | Gender: Female |
| Income Level: $100,000-$150,000 | Income Level: <$20,000 |
| Location: San Francisco, USA | Location: Buenos Aires, Argentina |
| Education: Master's Degree | Education: High School Diploma |
| Occupation & Industry: | Occupation & Industry: |
| Job Title: Software Engineer | Job Title: Barista |
| Industry Type: Technology | Industry Type: Hospitality |
| Interests | Interests: |
| Hobbies: Golf, Reading, Wine Tasting | Hobbies: Dancing, Social Media, Traveling |
| Lifestyle: Professional, Leisurely | Lifestyle: Fun-loving, Budget-conscious |
| Preferred Destinations: European Cities | Preferred Destinations: Beach Resorts |
| Food and Dining Preferences: Fine Dining | Food and Dining Preferences: Street Food |
| Dislikes: Budget accommodations | Dislikes: Boredom |
| Fears: Failure | Fears: Missing out (FOMO) |
| Pets: Charlie, Dog | Pets: Luna, Cat |
| Travel Style: Luxury Traveler | |

For example, as shown in Table I above, the user models can capture a high-level overviews of the users, and can be in a structured format to capture travel-related information in this use case example.

The personalized task execution engine (e.g., personal task agent) can craft a personalized travel plan. For example, the personalized task execution engine can integrate the structured user model into its decision-making process (e.g., auto-populating portions of a predetermined prompt, etc.).

In some embodiments, this integration can be achieved through a non-parametric approach, where the user model data is injected into the prompt provided to personalized task execution engine (e.g., personal agent). This engine can employ various planning strategies, such as Direct planning, Chain-of-Thought (CoT), ReAct, or Reflexion, to process the combined inputs and reason about the task.

For example, using a ReAct strategy, personalized task execution engine can break down the travel planning task into a series of thought and action phases, ensuring that each step, from booking a hotel to selecting a restaurant, is aligned with the user's profile. The resulting output can be a personalized result, such as a detailed, multi-day travel itinerary tailored to the user.

Table II below shows an example of a prompting mechanism for a personal LLM-based agent to generate a personalized travel plan, according to an embodiment of the present disclosure.

TABLE II
You are a proficient planner with a keen understanding of personal preferences and
styles. Based on the provided information, persona, and query, please give me a
detailed and personalized plan, including specifics such as flight numbers (e.g.,
F0123456), restaurant names, and accommodation names. Note that all the information
in your plan should be derived from the provided data and aligned with the persona
details. You must adhere to the format given in the example. Additionally, all
details should align with common sense. The symbol ‘-’ indicates that information is
unnecessary. For example, in the provided sample, you do not need to plan after
returning to the departure city. When you travel to two cities in one day, you
should note it in the ‘Current City’ section as in the example (i.e., from A to B).
Always prioritize the query constraints first, especially when they conflict with
personal preferences. Incorporate personal preferences as secondary considerations.

As shown above in Table II, the system prompt can be used for Direct and CoT systems, but embodiments are not limited thereto.

In addition, the AI agent can be given various examples for guiding generation of the output travel plan.

Table III below shows a one-shot example for guiding the model to generate responses in the style of the example plan, according to an embodiment of the present disclosure.

TABLE III
***** Example *****
Query: Could you create a travel plan for 7 people from Ithaca to Charlotte spanning
3 days, from March 8th to March 14th, 2022, with a budget of $30,200?
Personalized Travel Plan:
Day 1:
Current City: from Ithaca to Charlotte
Transportation: Flight Number: F3633413, from Ithaca to Charlotte, Departure Time:
05:38, Arrival Time: 07:46
Breakfast: restaurants_XXXX, Charlotte
Attraction: The Charlotte Museum of History, Charlotte
Lunch: restaurants_XXXX, Charlotte
Dinner: restaurants_XXXX, Charlotte
Accommodation: accommodations_XXXX, Charlotte
Day 2:
Current City: Charlotte
Transportation: -
Breakfast: restaurants_XXXX, Charlotte
Attraction: The Mint Museum, Charlotte: Romare Bearden Park, Charlotte
Lunch: restaurants_XXXX, Charlotte
Dinner: restaurants_XXX, Charlotte
Accommodation: accommodations_XXX, Charlotte
Day 3:
Current City: from Charlotte to Ithaca
Transportation: Flight Number: F3786167, from Charlotte to Ithaca, Departure Time:
21:42, Arrival Time: 23:25
Breakfast: restaurants_XX, Charlotte
Attraction: Books Monument, Charlotte
Lunch: restaurants_XXXX, Charlotte
Dinner: restaurants_XXXX, Charlotte
Accommodation: -
***** Example Ends *****

Further, to provide a benchmark for the value of personalization, the baseline task execution engine can operate in parallel to the personalized task execution engine, according to an embodiment of the present disclosure. The baseline task execution engine can receive the same user query and External Data/Tools but does not have access to the structured user model.

Also, the baseline task execution engine can use the same type of planning strategies as the personalized engine but without the user-specific context, but embodiments are not limited thereto. The output of the baseline task execution engine can be a generic result, such as a standard, non-personalized travel itinerary that, while functional, is not tailored to the individual user.

Table IV below shows an example for a generic plan and a corresponding output, according to an embodiment of the present disclosure.

TABLE IV
Query: “Can you create a travel plan for a group of 5 departing from
Charlotte heading to Hilton Head, to be carried out over 3 days, from
March 26th to March 28th, 2022? The budget for this trip is capped
at $7,000. We have a preference for Italian and French cuisines during our trip.”

```
[
  {
    “days”: 1,
    “current_city”: “from Charlotte to Hilton Head”,
    “transportation”: “Flight Number: F4055090, From Charlotte to Hilton Head,
    Departure Time: 18:07, Arrival Time: 19:27”,
    “breakfast”: “Name: Hunger's Hub, Cuisines: Tea, Bakery, Desserts, Seafood,
    Average Cost: 97, Aggregate Rating: 3.1, Hilton Head”,
    “attraction”: “Coastal Discovery Museum, Hilton Head”,
    “lunch”: “Name: Ashirbad, Cuisines: Pizza, Bakery, Mediterranean, Seafood,
    Average Cost: 50, Aggregate Rating: 3.6, Hilton Head”,
    “dinner”: “Name: Wrapster, Cuisines: French, Seafood, Desserts, Italian,
    Average Cost: 18, Aggregate Rating: 3.2, Hilton Head”,
    “accommodation”: “Name: Hip, Vibrant, COLORFUL Downtown Manhattan 1 Bed,
    room type: Entire home/apt. price: 763.0, minimum nights: 2.0, review rate
    number: 1.0, house_rules: No visitors, maximum occupancy: 7, Hilton Head”
  },
  {
    “days”: 2,
    “current_city”: “Hilton Head”,
    “transportation”: “-”,
    “breakfast”: “Name: Hunger's Hub, Cuisines: Tea, Bakery, Desserts, Seafood,
    Average Cost: 97, Aggregate Rating: 3.1, Hilton Head”,
    “attraction”: “Harbour Town Lighthouse, Hilton Head; Coligny Beach Park,
    Hilton Head”,
    “lunch”: “Name: Ashirbad, Cuisines: Pizza, Bakery, Mediterranean, Seafood,
    Average Cost: 50, Aggregate Rating: 3.6, Hilton Head”,
    “dinner”: “Name: Wrapster, Cuisines: French, Seafood, Desserts, Italian,
    Average Cost: 18, Aggregate Rating: 3.2, Hilton Head”,
    “accommodation”: “Name: Hip, Vibrant, COLORFUL Downtown Manhattan 1 Bed,
    room type: Entire home/apt, price: 763.0, minimum nights: 2.0, review rate
    number: 1.0, house_rules: No visitors, maximum occupancy: 7, Hilton Head”
  },
  {
    “days”: 3,
    “current_city”: “from Hilton Head to Charlotte”,
    “transportation”: “Flight Number: F4056985, from Hilton Head to Charlotte,
    Departure Time: 20:07, Arrival Time: 21:31”,
    “breakfast”: “Name: Hunger's Hub, Cuisines: Tea, Bakery, Desserts, Seafood,
    Average Cost: 97, Aggregate Rating: 3.1, Hilton Head”,
    “attraction”: “Books Monument, Charlotte”,
    “lunch”: “Name: Ashirbad, Cuisines: Pizza, Bakery, Mediterranean, Seafood,
    Average Cost: 50, Aggregate Rating: 3.6, Hilton Head”,
    “dinner”: “Name: Wrapster, Cuisines: French, Seafood, Desserts, Italian,
    Average Cost: 18, Aggregate Rating: 3.2, Hilton Head”,
    “accommodation”: “-”
  }
]
```

Further still in the example, both the personalized result and the generic result can be transmitted to the automated personalization quality assessor (e.g., evaluation engine or module). This component can be configured as an LLM-as-a-Judge to perform a comparative evaluation.

For example, the assessor can be provided with the structured user model and the original user query. The assessor can evaluate which of the two itineraries better matches the user's preferences and requirements. According to an example situation, the assessor could identify that the personalized plan is superior because it selected a hotel that allows pets, aligning with the user's profile.

The process can further include the assessor issuing a verdict with justification, which confirms the effectiveness of the personalized approach. Due to the handling of potentially sensitive user data, this entire framework can be deployed on one or more edge devices, which can ensure user privacy. Also, according to an embodiment, the agents can be based on quantized versions of LLM models (e.g., 16fp to 8bit or 4bit, etc.)

In addition, the automated personalization quality assessor can employ a series of objective performance indicators to evaluate both the personalized result and the generic result, which can include one or more of a delivery metric, a common-sense pass metric, a hard constraint pass metric, and a final pass metric. These metrics can provide a quantitative measure of the functional quality of the generated plans.

For example, the evaluation can include a delivery rate which measures whether the respective execution engine successfully produced an output in response to the query that was accepted by a user or by an LLM as judge, and/or is error free.

In addition, a hard constraint pass metric can be used to measure whether a plan adheres to the non-negotiable parameters defined in the user query. For instance, if the query specifies a travel budget of $3,200 and a duration of three days, a plan that costs more than $3,200 or that includes activities outside the specified three-day window would fail this hard constraint check. This metric can help ensure that the fundamental requirements of the user's request have been met.

Further, a common-sense pass metric can be employed to evaluate the logical and practical feasibility of the generated plan. This metric can assess whether the suggestions in the itinerary are reasonable in a real-world context.

For example, a travel plan that suggests visiting a museum at 3:00 AM in the morning, schedules two events in different cities at the same time, or recommends an outdoor picnic during a forecasted hurricane would fail the common-sense pass rate. This can ensure the generated plan is technically compliant and practically viable.

In addition, a final pass metric can be determined as a composite metric that indicates whether a generated plan has successfully passed one or more of the preceding objective checks (e.g., or passed all of the preceding checks). For example, a plan, whether personalized or generic, can achieve a final pass if it was successfully delivered, adhered to all hard constraints, and was deemed to be common-sensically valid, according to an embodiment of the present disclosure.

Table V below shows a prompt example for preference evaluation on the non-personalized plans and the personalized plans, according to an embodiment of the present disclosure.

TABLE V
You are a evaluator for travel plans. You are provided the persona of the traveller
and two travel plans named N and P. You should pick the more suitable plan based on
the traveller persona. Output only N or P for choosing between the two plans. The
persona of the traveller is {persona}. The N plan is {n_plan}. The P plan is {p_plan}.

Table VI below shows reasoning examples output from the LLM-as-a-Judge explaining its preferences for personal plans over generic plans for selected validation queries, according to an embodiment of the present disclosure.

TABLE VI

| Query ID | Reasoning |
|---|---|
| val-56 | “The second plan has more varied food options, |
| | a longer stay in Orlando with multiple |
| | attractions, and no flight which might be stressful |
| | for the traveler.” |
| val-72 | “Luxury Traveler prefers fine dining and high- |
| | end accommodations, both plans provide suitable |
| | options, but Plan P has a more consistent |
| | high-end dining experience” |
| val-81 | “The P plan has more luxurious accommodations, |
| | which suits the traveller's taste.” |
| val-122 | “Pet-friendly accomodation” |
| val-142 | “Plan P accommodates traveller's preferences |
| | for European cities, fine dining, and luxury |
| | travel” |

Also, according to an embodiment, a plurality of synthetic plans can be generated for evaluating the effectiveness of the method by using synthetic personas generated by an AI agent, which can be used as inputs into the above framework for further evaluation results.

Table VII below shows an example of a user model generation prompt, according to an embodiment of the present disclosure.

TABLE VII
You are an expert. Complete N distinct and diverse user personas in a structured
format requested as follow. Choose specific answers to each of the fields. For the
fields that are optional, you can randomly choose to fill them or remove them from
the persona. Remove the optional flag from the field.
Persona:
Demographics:
Age Range:
Gender:
Income Level:
Location:
Education:
Occupation & Industry:
Job Title:
Industry Type:
Interests:
Hobbies:
Lifestyle:
Preferred Destinations [optional]:
Food and Dining Preferences [optional]:
Dislikes:
Fears:
Pets [optional]:
Travel Style [optional]:
Think critically step by step to create a user persona.

Evaluation results of the synthetic data is discussed in more detailed at a later section below.

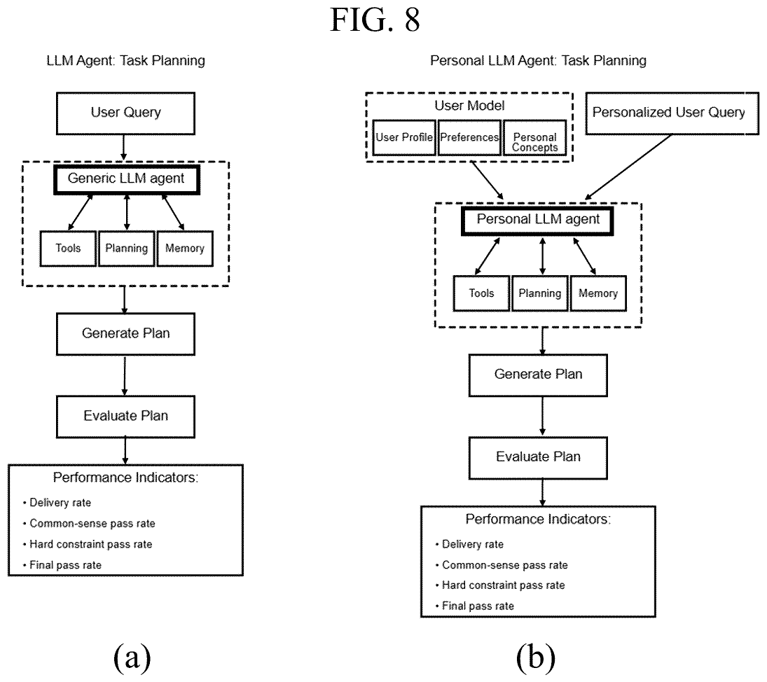

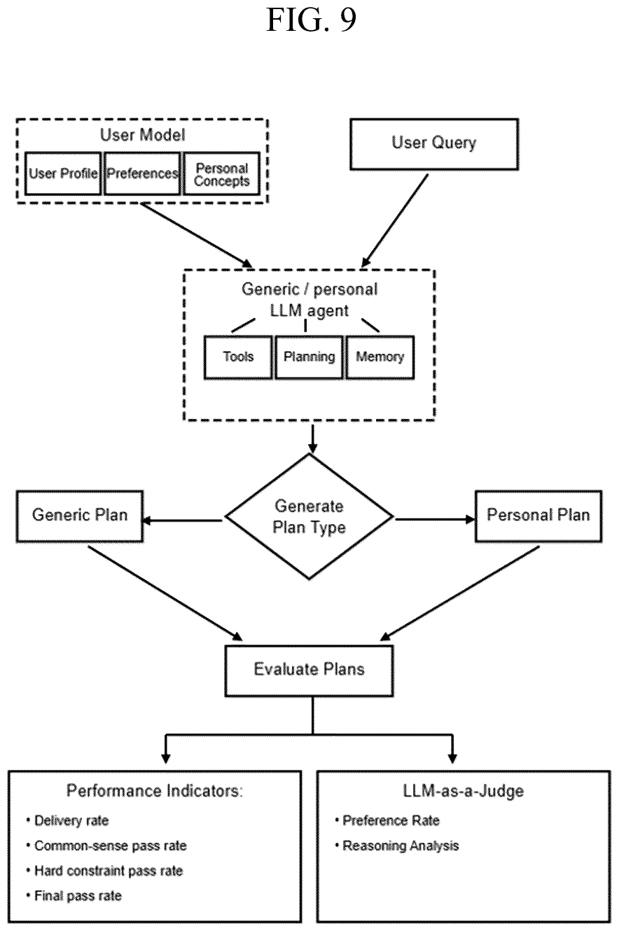

FIG. 8, including parts (a) and (b), illustrates a comparison between a non-personalized task planning workflow (e.g., non-personalized task planning workflow) shown in FIG. 8(a), and a personalized task planning workflow shown in FIG. 8(b). Both workflows can receive a user's request, generate a plan, and evaluate the output. However, the personalized workflow in FIG. 8(b) incorporates user-specific context to produce a tailored result.

According to an embodiment, the non-personalized task planning workflow and personalized workflow can be implemented as separate pipe-lines with their own LLM-based agents, but embodiments are not limited thereto.

Further, as shown in FIG. 8(a), the non-personalized workflow can receive a user query, e.g., an instruction from the user. This query can be sent to anon-personalized LLM agent. The agent utilizes its internal components, including tools (e.g., APIs, databases), a planning module to structure the task and memory for context, to process the query.

Also, the non-personalized agent can then generate a non-personalized plan. This plan can be sent to an evaluate plan stage, where it is assessed against a set of objective performance indicators, such as delivery rate, common-sense pass rate, hard constraint pass rate, and final pass rate.

Further in this example, as shown in FIG. 8(b), the personalized workflow introduces a user model as an additional input. This user model can contain the user's user profile, preferences, and personal concepts. Both the user model and a personalized user query can be supplied to the personal LLM agent. The personal LLM agent, using its own tools, planning and memory, can integrate this rich user context to a generate a personalized plan.

Then, this personalized plan can be subjected to an evaluate plan stage, where it is measured against the set of objective performance indicators. In this way, the personal agent can leverage the user model to create a plan that is functionally correct and personally relevant to the user.

Various experiments were carried out to evaluate the results for the pipeline architecture and method, according to embodiments.

Table VIII below shows performance indicators (%) of different LLM agents and planning strategies on the TravelPlanner validation set (e.g., for 20 synthetically generated user models). The Personal plans are averaged over 5 user models. The best outcomes are in bold, and the second-best outcomes are underlined.

TABLE VIII

| | Generic plans | | | | | | Personal plans | | | | | |
|---|---|---|---|---|---|---|---|---|---|---|---|---|
| | | Commonsense | | Hard Constraint | | Final | | Commonsense | | Hard Constraint | | Final |
| Planning | Delivery | Pass Rate | | Pass Rate | | Pass | Delivery | Pass Rate | | Pass Rate | | Pass |
| strategy | Rate | Micro | Macro | Micro | Macro | Rate | Rate | Micro | Macro | Micro | Macro | Rate |

GPT-3.5-Turbo

| | | | | | | | | | | | | |
|---|---|---|---|---|---|---|---|---|---|---|---|---|
| Direct | 100 | 67.15 | 3.33 | 20.24 | 5.00 | 0 | 100 [symbol] | 65.67 [symbol] | 3.67 [symbol] | 24.12 [symbol] | 6.33 [symbol] | [symbol] |
| CoT | 100 | 66.94 | 3.33 | 20.95 | 9.44 | 1.11 | 99.66 [symbol] | 65.21 [symbol] | 5.00 [symbol] | 20.32 [symbol] | 6.67 [symbol] | 0.59 [symbol] |
| ReAct | 100 | 64.44 | 2.22 | 9.28 | 2.78 | 0 | 99.89 [symbol] | [symbol] | 1.56 [symbol] | 4.62 [symbol] | 1.00 [symbol] | 0 [symbol] |
| Reflexion | 100 | 63.47 | 0.56 | 3.57 | 1.11 | 0 | 99.44 [symbol] | 64.14 [symbol] | 1.34 [symbol] | 9.76 [symbol] | 2.67 [symbol] | 0 [symbol] |

Llama-3-8B-Instruct

| | | | | | | | | | | | | |
|---|---|---|---|---|---|---|---|---|---|---|---|---|
| Direct | 100 | 76.53 | 16.11 | 31.67 | 8.33 | 1.67 | 98.89 [symbol] | 73.16 [symbol] | 11.78 [symbol] | 18.33 [symbol] | 7.33 [symbol] | 1.22 [symbol] |
| CoT | 98.89 | 69.65 | 8.33 | 16.43 | 5.00 | 2.22 | 98.89 [symbol] | [symbol] | 4.67 [symbol] | 11.71 [symbol] | 4.78 [symbol] | 0.89 [symbol] |
| ReAct | 45.00 | 32.01 | 2.78 | 4.28 | 1.67 | 0 | 35.89 [symbol] | 25.59 [symbol] | 1.22 [symbol] | [symbol] | 1.22 [symbol] | 0.11 [symbol] |
| Reflexion | 52.22 | 37.15 | 2.22 | 9.76 | 1.67 | 0.56 | 34.67 [symbol] | 24.33 [symbol] | 1.00 [symbol] | 6.33 [symbol] | 2.78 [symbol] | 0.22 [symbol] |

[symbol]

indicates data missing or illegible when filed

As shown above, Table VIII presents a comparative analysis of the performance of two distinct Large Language Models (LLMs), GPT-3.5-Turbo and Llama-3-8B-Instruct, in generating both “Generic plans” and “Personal plans” according to various embodiments. The evaluation was conducted across four different planning strategies: Direct, Chain-of-Thought (CoT), ReAct, and Reflexion. The performance was measured using several objective metrics, including Delivery Rate, Common-sense Pass Rate (with both Micro and Macro averages), Hard Constraint Pass Rate (with both Micro and Macro averages), and Final Pass Rate.

The evaluation results highlight significant advantages of the disclosed framework. For example, when using the GPT-3.5-Turbo model, the personal plans consistently achieved a higher Hard Constraint Pass Rate (e.g., 24.12 for the Direct strategy) compared to the generic plans (20.24), and a higher final pass rate for the Direct strategy. This demonstrates that integrating the structured user model does more than just tailor the output to subjective preferences; it also provides the agent with crucial context that improves its ability to adhere to the explicit, non-negotiable constraints of a user's query, leading to a more reliable and accurate final result.

In addition, the evaluation results show that sometimes the generic plans show better performance in some situations. Thus, as discussed above, the method can include selecting and outputting the non-personalized plan in certain situations and can provide the non-personalized plan as an option.

According to one or more embodiments of the present disclosure, the AI device 100 can solve one or more technological problems in the existing technology, such as implementing a personalized task execution framework for large language model (LLM) agents that can provide enhanced user alignment and quantitative measurement of the personalization's effectiveness.

For example, embodiments of the present disclosure can address the deficiencies of the related art LLM agents, which suffer from an inability to understand a user's individual context, a reliance on generic, one-size-fits-all outputs that are poorly aligned with user needs, and the absence of a robust framework to quantitatively evaluate the quality of personalization.

Also, according to an embodiment, the AI device 100 configured with the method can be used in a mobile terminal, a smart TV, a home appliance, a robot, an infotainment system in a vehicle, etc.

For example, the AI device and method can be applied in a wide range of interactive applications where a deep understanding of a user's personal context can enhance the quality and relevance of the output. The disclosed framework is not limited to generating static plans but can be applied to a variety of complex and dynamic tasks.

For example, the personal agent can be embodied as a personalized financial advisor, a customized fitness and nutrition coach, a personalized career and education counselor, an automated content and entertainment curator, or a personalized shopping assistant and stylist, among other applications.

In an embodiment as a personalized financial advisor, the structured user model can contain the user's financial goals, risk tolerance, income and ethical investing preferences. For example, the personal agent can then create a personalized investment portfolio, suggest tailored budgeting strategies and recommend financial products that are uniquely suited to the user's specific financial situation.

In another embodiment as a customized fitness and nutrition coach, the user model can contain the user's health goals, dietary restrictions and available exercise equipment, allowing the agent to generate weekly workout routines and daily meal plans that are precisely aligned with the user's lifestyle and objectives.

The personal agent can also be configured to perform more dynamic tasks beyond planning. In an embodiment as a personalized content creation and communication assistant, the user model can contain the user's specific writing style and tone. For example, the agent can be instructed to draft documents, such as emails and reports that are also written in the user's unique voice.

In another embodiment as an adaptive tutor, the user model can contain a student's knowledge level and preferred learning style, enabling the agent to provide customized hints and explanations that are tailored to the student's specific learning needs.

Further, the methods and systems disclosed herein have broad applicability across the consumer electronics industry. The personal agent framework can be integrated into devices such as AI-PCs, laptops, smart televisions, and smart home appliances to provide a differentiated and enhanced user experience.

For example, on an AI-PC, the agent can tailor the generation of emails, presentations and reports to a user's individual preferences. Within a smart home ecosystem (e.g., such as the LG ThinQ app), the framework can make the system a central hub for personalized services to provide tailored content recommendations on a smart TV or customized meal plans on a smart refrigerator, in addition to appliance control.

In an enterprise context, the framework can be used to develop specialized virtual assistants for customer service or internal helpdesks. By leveraging a user model for each employee, the agent can provide support and information that is contextually relevant to that employee's role, department and access permissions. The ability to deploy such a system on-device (e.g., via quantization) or within a secure private cloud also addresses significant data privacy and security concerns to enable companies to build powerful, personalized AI tools without exposing sensitive corporate or customer data to third-party services.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
obtaining, via a processor in the AI device, a user query and user-related information, the user related information includes one or more of user preferences, user history and user personal concepts;
generating, by a structured user model synthesizer, a structured user model based on the user-related inputs;
generating, by a personalized task execution engine, a personalized result for the user query by integrating the structured user model and external data; and
outputting the personalized result,
wherein at least one of the structured user model synthesizer and the personalized task execution engine is a large language model based agent.

2. The method of claim 1, further comprising:
generating, by a baseline task execution engine, a non-personalized result for the user query based on the external data and without using the structured user model;
evaluating, by an automated personalization quality assessor, the personalized result and the non-personalized result being based on the structured user model and the user query; and
generating, by the automated personalization quality assessor, a verdict identifying a preferred result between the personalized result and the non-personalized result.

3. The method of claim 2, further comprising:
selecting one of the personalized result and the non-personalized result based on the verdict to determine a selected result; and
outputting the selected result.

4. The method of claim 2, wherein the automated personalization quality assessor is a large language model (LLM) configured as an LLM-as-a-Judge.

5. The method of claim 2, wherein the evaluating further includes:
assessing the personalized result and the non-personalized result based on one or more performance indicators including one or more of a delivery metric, a common-sense pass metric, a hard constraint pass metric, and a final pass metric.

6. The method of claim 2, wherein the verdict further includes a detailed justification explaining identification of the preferred result.

7. The method of claim 1, wherein the structured user model synthesizer is a large language model (LLM) based agent configured to populate a predefined schema based on the user-related information.

8. The method of claim 1, wherein the structured user model synthesizer includes a retrieval augmented generation (RAG) architecture.

9. The method of claim 1, wherein the integrating the structured user model includes a non-parametric approach of incorporating data from the structured user model into a prompt for the personalized task execution engine.

10. The method of claim 1, wherein the integrating the structured user model includes a parametric approach of adapting the personalized task execution engine to the structured user model using at least one of fine-tuning, adapter layers, Low-Rank Adaptation (LoRA), and soft prompt tuning.

11. The method of claim 1, wherein the personalized task execution engine is a large language model (LLM) agent that employs a planning strategy selected from a group including Direct, Chain-of-Thought (CoT), ReAct, and Reflexion.

12. An artificial intelligence (AI) device, comprising:
a memory configured to store information for a large language model; and
a controller configured to:
obtain a user query and user-related information, the user related information includes one or more of user preferences, user history and user personal concepts,
generate, by a structured user model synthesizer, a structured user model based on the user-related inputs,
generate, by a personalized task execution engine, a personalized result for the user query by integrating the structured user model and external data, and
output the personalized result,
wherein at least one of the structured user model synthesizer and the personalized task execution engine is a large language model based agent.

13. The AI device of claim 12, wherein the controller is further configured to:
generate, by a baseline task execution engine, a non-personalized result for the user query based on the external data and without using the structured user model,
evaluate, by an automated personalization quality assessor, the personalized result and the non-personalized result based on the structured user model and the user query, and
generate, by the automated personalization quality assessor, a verdict identifying a preferred result between the personalized result and the non-personalized result.

14. The AI device of claim 13, wherein the controller is further configured to:
select one of the personalized result and the non-personalized result based on the verdict to determine a selected result, and
output the selected result.

15. The AI device of claim 13, wherein the controller is further configured to:
assess, via the automated personalization quality assessor, the personalized result and the non-personalized result being based on one or more performance indicators including one or more of a delivery rate, a common-sense pass rate, a hard constraint pass rate, and a final pass rate.

16. The AI device of claim 13, wherein the automated personalization quality assessor is a large language model (LLM) configured as an LLM-as-a-Judge.

17. The AI device of claim 13, wherein the controller is further configured to:
assess, via the automated personalization quality assessor, the personalized result and the non-personalized result based on one or more performance indicators including one or more of a delivery metric, a common-sense pass metric, a hard constraint pass metric, and a final pass metric.

18. The AI device of claim 12, wherein the structured user model synthesizer includes a retrieval augmented generation (RAG) architecture.

19. The AI device of claim 12, wherein the integrating the structured user model includes a non-parametric approach of incorporating data from the structured user model into a prompt for the personalized task execution engine.

20. A non-transitory computer readable medium storing computer-executable instructions that when executed by a processor, cause the processor to perform the operations of:
obtaining a user query and user-related information, the user related information includes one or more of user preferences, user history and user personal concepts;
generating, by a structured user model synthesizer, a structured user model based on the user-related inputs;
generating, by a personalized task execution engine, a personalized result for the user query by integrating the structured user model and external data; and
outputting the personalized result,
wherein at least one of the structured user model synthesizer and the personalized task execution engine is a large language model based agent.
